(19) United States
(12) Patent Application Publication
(10) Pub. No.: US 2026/0369471 A1
(43) Pub. Date: Nov. 19, 2026

(54) METHOD FOR INCREASING SKIN DEPTH AND REDUCING EDDY CURRENTS IN HYBRID MAGNETIC CORES AND COMPOSITE METALS USING ELECTROLESS PLATING TECHNIQUES AND RESULTING APPARATUS

(71) Applicant: Atlas Magnetics, Reno, NV (US)

(72) Inventors: John Othniel McDonald, Reno, NV (US); Zachary Zimits, Reno, NV (US)

(21) Appl. No.: 19/147,898

(22) PCT Filed: Jan. 12, 2024
(86) PCT No.: PCT/US24/11348

§ 371 Date: Jul. 14, 2025

Related U.S. Application Data
(63) Continuation-in-part of application No. 18/131,350, filed on Apr. 5, 2023.

(51) Int. Cl. H01F 41/26; C23C 18/16; C23C 18/50

(52) U.S. Cl. CPC H01F 41/26; C23C 18/1639; C23C 18/1648; C23C 18/50

(57) ABSTRACT

A pinched hybrid magnetic material and methods of making said pinched hybrid material. The material comprises at least one magnetic material having at least one internal porous insulative layer; wherein, at least one of the voids is pinched off and filled with environmental material. The pinched voids are created by an electroless plating process.

### BACKGROUND

Power designers seek to shrink the size, cost, and weight of power devices and are often limited by the requirements of the magnetic devices in the system. The introduction of hybrid magnetic materials introduced the concept of imperfect insulation layers (hybrid insulation), which the magnetic layers could penetrate and connect through allowing for small, low-cost, and high-resistivity metal cores suitable for many high-frequency applications as they greatly increased the directional resistivity over bulk magnetic materials.

However, the introduction of hybrid magnetic materials also introduced new problems mainly in regard to the insulation layers. So, although it broke through the performance barriers of the past low-cost materials it had limits of its own. The problem with insulation that allows the surrounding layers to connect is that it is far from a perfect insulator. Because the physical and cost benefits of a hybrid insulation layer come from the imperfections, increasing the strength of the imperfect insulation layers without sacrificing those benefits is a complex issue.

However, having a stronger insulation layer would allow for even better efficiency, smaller sizes, and higher frequency operation—allowing the hybrid magnetic material even higher limits and better performance. For example, with boost and buck converters, it is well known that an increase in switching frequency will result in a decrease in switching efficiency and an increase in switching loss. These inefficiencies primarily derive from eddy current generation. However, having a stronger insulation layer will reduce eddy current generation and allow for higher frequency switching frequencies to be utilized within the component. If higher switching frequencies are unlocked, then components incorporating hybrid magnetic materials can efficiently and directly connect to various power sources, including Li-Ion batteries.

Therefore, it may be beneficial to increase the insulative strength of the imperfect insulation layers further in applications where further reduction in not only eddy currents but any current flowing perpendicular to the layering in the composite material while keeping resistivity low for currents flowing parallel to the layering.

### BRIEF SUMMARY OF THE INVENTION

The present application presents a method for manufacturing an imperfect insulation layer with increased insulative strength and the resulting apparatus by pinching the voids. Hybrid magnetic materials as referred to in this application, are materials with an imperfect insulation layer (hybrid insulation layer), which is one that contains voids. These through voids are typically filled by non-insulative layer material, which interconnects layers through the insulation. The method discussed herein increases the imperfect insulation layer's insulation strength without resorting to relatively expensive insulating polymers, epoxy films, coatings applied at temperatures, pressures, or processes that are incompatible with semiconductor packaging epoxy plastics, semiconductor wafers, or printed circuit boards. Thus, the apparatus is a hybrid magnetic material with at least one pinched void hybrid insulation layer. This hybrid magnetic material can be shaped into many components, and some resulting components may include wiring or traces. The increased insulative strength will increase the ability of the insulation layers to reduce eddy current formation and thus provide a greater composite skin depth for the components it is integrated into.

The method involves depositing a hybrid insulation layer onto a layer of a magnetic component. The formation of the hybrid insulation layer is followed by the electroless plating (controlled autocatalytic deposition) of a subsequent magnetic layer onto the previously deposited hybrid insulation layer. The electroless plating occurs at least until the thickness of the new metal layer starts to close off the voids in the hybrid insulation layer. Electroless plating may be continued to create a component layer, or electroplating or other means may be utilized to finish the next component metal layer.

The resulting apparatus is a hybrid magnetic material with a pinched void insulation layer, which can be shaped into a component or component part. Unlike a traditional hybrid insulation layer where the electroplated magnetic material is deposited next, not all of the voids are entirely filled with electroless deposited metal, although some will be. These voids may contain air, liquid, and oxide of the nearby metals and, in most cases, contain some aspect of the electroless plating or pre-plating environment. The pinched voids' resistance is much higher than the resistance of nickel-iron or other magnetic metals, which would otherwise fill the voids as in the case of standard electroplating deposition. Thus, the resistivity of the hybrid magnetic material insulation layers has been increased—improving their function as insulators. Experimental data suggests the resistivity increase is at least two orders of magnitude higher as compared to a CCVD SiO₂ deposited hybrid layer that has been electroplated vs. this electroless method as the following layer.

The resulting apparatus of the present invention is referred to as a pinched hybrid magnetic material because it pinches voids of the imperfection insulation layer off. A pinched hybrid material can have a stronger unique conductivity, skin effect, B-H curve, B_{SAT} parameters, and a unique and strong directional impedance than traditional hybrid materials ((hybrid materials that go directly from insulation layer formation to electroplating).

### BRIEF DESCRIPTION OF THE FIGURES

FIG. 1 is a cross-section view of a particulate hybrid insulation layer on a magnetic material.

FIG. 2 is a cross-sectional view of electroless metal deposited on a particulate insulation layer.

FIG. 3 is a cross-sectional view of a particulate void that has been pinched off.

FIG. 4 is a cross-sectional view of a particulate void that will not be pinched off.

FIG. 5 is a cross-sectional view of a particulate void that will be partially pinched off.

FIG. 6 is a cross-sectional view of a non-particulate void that will be pinched off.

FIG. 7 is a cross-section view of an electroplated metal layer on a particulate hybrid insulation layer that previously received electroless plating.

FIG. 8 is a flow chart showing cross-sectional views of each step of an additive component manufacturing process incorporating the method of the present invention.

FIG. 9 is a flow chart showing cross-sectional views of each step of an additive component manufacturing process incorporating a mix of traditional hybrid material insulation layers and pinched hybrid insulation layers.

### DETAILED DESCRIPTION OF INVENTION

The present invention involves forming magnetic components with hybrid magnetic materials where the hybrid insulation layer is pinched by an electroless insulation process to create a pinched gap hybrid magnetic material. The present invention's method is particularly useful for enabling high-frequency capable magnetic components by providing a robust, low-cost insulation layer capable of reducing eddy currents and thus increasing the effective skin depth of the component. This method is beneficial for creating high-frequency capable cores by providing a robust, low-cost insulation layer capable of reducing eddy current formation and thus reducing energy loss in the core. As this method can increase insulation resistivity up to and exceeding two times that of traditional hybrid materials, it enables better-performing and smaller magnetic cores.

It is worth briefly discussing the physical characteristics of hybrid materials in general. A hybrid material will have an imperfect insulation layer. This insulation layer may be generated in multiple ways, but the two most economically viable methods are by chemical combustion vapor deposition and ink jet printing. With chemical combustion vapor deposition, the insulation layer will be comprised of particulates and have a random assortment of voids between the particulates, although the voids can be controlled somewhat by controlling the thickness of the layer. With ink printing, the insulation layer will generally be a solid sheet of insulation with purposely placed voids. In either method of forming the imperfect insulation layer, there are through-layer voids that will be filled when a subsequent non-insulative layer is formed. This hybrid material has much more vertical resistivity than a generic bulk material.

This increase in vertical resistivity will greatly reduce the specific eddy current power loss per unit volume (P_{ec,sp}) of the hybrid magnetic material as can be seen from the following equation, where ρ_{core} is the resistivity of the lamination.

$${P}_{ec , sp} = \frac{{d}^{2} {ω}^{2} {B}_{ma x}^{2}}{24 {ρ}_{core}} \qquad ( 1 )$$

As can be seen in equation (1), eddy current loss is exponentially related to lamination thickness and inversely proportional to the resistivity! To keep that vertical resistivity at an effective level throughout the component

Where the electroless method of creating pinched imperfect insulation layers shines is that it allows for the layers to maintain the tight grouping of traditional hybrid materials as the electroless plating can be directly followed by electroplating, or if desired, a subsequent insulation layer.

Electroless plating is a method to take a portion of the voids off while still allowing some through-layer voids to be filled and connect layers through the insulation. It does not increase layer thickness.

The pinched gaps do, however, increase the strength of the insulation layer by creating highly resistive gaps, which is achieved by electroless plating a layer on the hybrid insulation layer. Because, unlike going from the insulation layer directly to electroplating, which will not form metals on the insulation layer, the electroless plating will deposit on the insulation layer. Given the random nature and shape of the voids in a particulate hybrid layer some voids will be pinched off while others remain. With a printed hybrid insulation layer, the voids may be printed in a manner that allows at least some to be pinched.

After the electroless method pinches at least some of the voids or is estimated to have pinched some of the voids, electroplating or other forms of plating may be used to complete the subsequent layer if desired. Thus, a combination of both high-resistivity electroless plating and the cheaper but lower-resistivity electroplating method of depositing a metal on top of hybrid insulation may be used to achieve a desired economic vs. performance balance.

While the preferred insulative material with hybrid materials is CCVD SiO₂ due to how well SiO₂ is studied, its non-toxic and relatively inert properties, and low cost, any generated oxide or form may be used with some success to generate a higher resistance layer within a magnetic material.

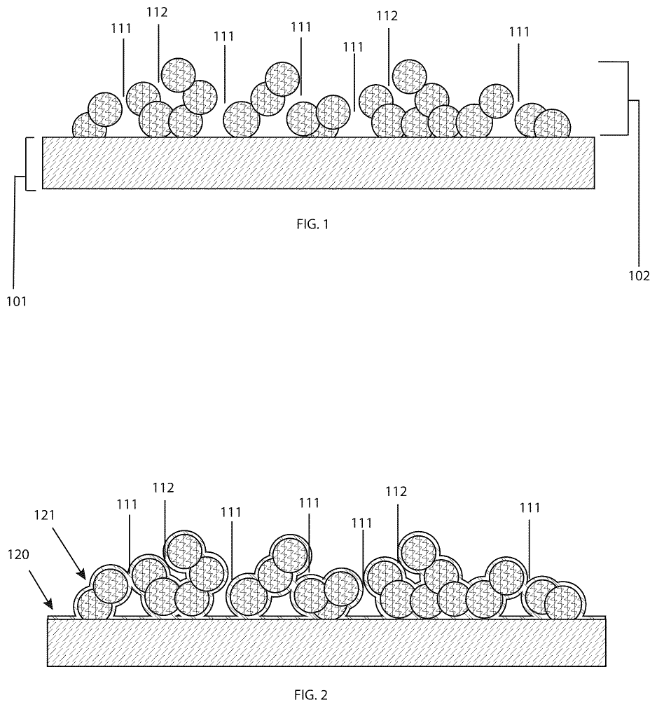

When the hybrid insulation layer is particulate-based, the pinching of voids will occur at random. FIG. 1 shows a magnetic material layer 101 having a hybrid insulation layer 102, on its upper surface. The magnetic material layer 101 may be a nickel-iron alloy or any metal or magnetic material that could be used for the same purpose as nickel-iron. In the exemplary embodiment demonstrated by FIG. 1, the magnetic layer is nickel-iron, and the hybrid insulation layer 102 is SiO₂, which has been randomly distributed. (This random distribution happens because the SiO₂ falls like snow after a combustion reaction from a CCVD process). Note that some SiO₂ particles embed in the metal layer due to their heat as combustion products. It is also worth noting that the SiO₂ particulates making up the SiO₂ layer 102 may fall in any random pattern, and this figure is only demonstrative of a pattern the SiO₂ particles may form.

There are several large through voids 111 between the SiO₂ particles. These voids 111 present through holes that transverse the entire cross-section of the hybrid insulation layer 102. Other significant voids 112 may also exist, which do not transverse the entire cross-section of the SiO₂ layer 102 and may or may not be pinched off depending on how they form.

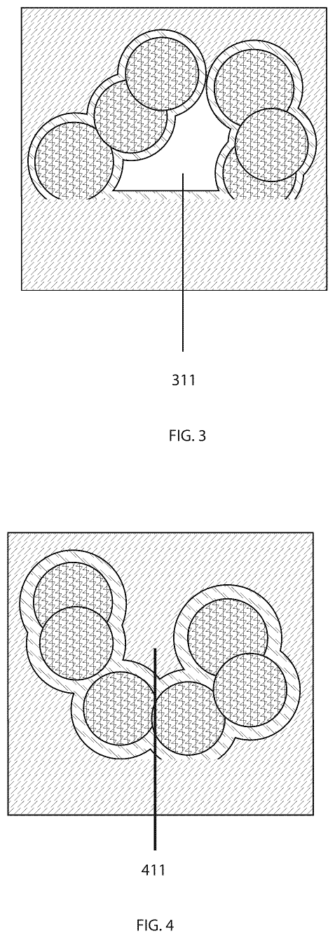

FIG. 2 shows an electroless magnetic material layer plated onto the hybrid insulation layer 102 and the magnetic layer 101 of FIG. 1 (shown as NiFe). A thin layer can be seen on the exposed portions of the SiO₂ surfaces and the metal layer's upper surface. The electroless NiFe layer plated onto the initial NiFe layer is layer 120, and the electroless NiFe layer plated onto the SiO₂ layer is NiFe layer 121. Because electroless plating is non-discriminatory, it will plate on all exposed surfaces, including the insulation layer. Voids that are not too large will be pinched off once the electroless layer grows thick enough during plating. This will prevent those voids from receiving deposits. Thus, the 111 gaps and the 112 gaps can become pinched off, preventing them from receiving further deposits.

Gaps closed off by the electroless plating method contain some environmental material. The environmental material could be controlled by controlling the plating or pre-plating environment.

Voids closed off by the electroless plating method contain some environmental material and are not necessarily pure air gaps. The environmental material could be controlled by controlling the plating or pre-plating environment.

FIG. 3 focuses on a demonstrative particulate void 311 that widens as it goes from top to bottom. The top of void 311 has closed off from electroless plating before the lower volume of the void is filled; thus, there is a void 311 left in the hybrid insulation layer, which is not filled.

FIG. 4 focuses on a demonstrative void 411, which narrows as it goes from top to bottom. Here the electroless plating will not close off void 411, and so void 411 will be filled with metal 121 by either the electroplating method or the electroless plating if the void is narrow enough.

However, not all voids uniformly change in width. FIG. 5 shows a void 511 having a thinner pinch point 520 beneath an initial opening, which then widens again to form a lower area 521. electroless plating has closed off the pinch point 520 of void 511; with metal 121, only the space above the pinch point has been plated with metal. Voids with a narrower portion that is narrow enough to be closed by some initial electroless plating before widening at some point will create the insulating voids of the invention.

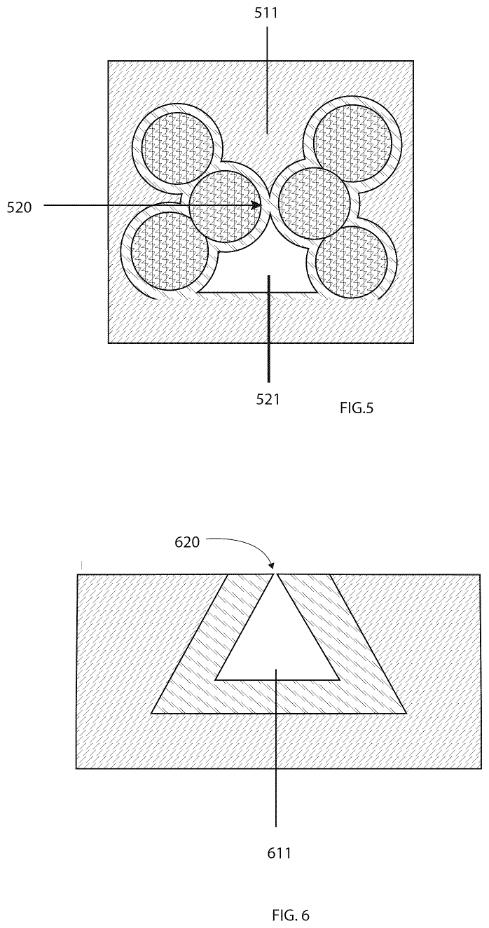

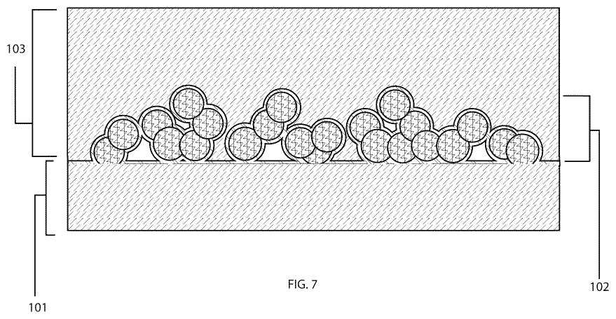

This principle which controls what voids are pinched off can be exploited in more controlled manufacturing processes, for example, ink printing. In an ink printing method of forming a hybrid insulation layer, the hybrid insulation layer is printed, and the voids are systematically designed and placed. As shown in FIG. 6, when the voids 611 are placed so that the opening 620 is narrow compared to the rest of the void, electroless plating will pinch off if the opening 620 is narrow enough.

FIG. 7 shows the hybrid insulation layer from FIG. 2 now having the subsequent metal layer built upon it. This layer may be built but is not limited to being built by electroplating or electroless plating. The steps shown in FIG. 1, FIG. 2, and FIG. 7 may be repeated until the desired component has been built.

The hybrid insulation layer of the present invention in particulate form is imperfect and consists of loose particulates embedded in the metal layer—it is not a complete single-piece insulation layer. As such, it is very susceptible to subtractive manufacturing processes, including etching and drilling. In subtractive manufacturing processes, even if the particulates are SiO₂ the particulates behave in a dust-like manner: in etching processes, for example, the silicon dioxide particulates are washed away, and in drilling processes, the silicon dioxide does not present a resistive barrier to the drill and is cleared with metal.

In regard to acid etches, because the pinched hybrid insulation layer can exist in particulate form with through-voids, the etching acid will etch through the voids. This property allows any etching acid to be used, which is useful for etching the metal around the insulation. Thus, to etch, simply utilize the etching acid suitable for etching the metal layers.

Non-particulate hybrid insulation layers do not have the ease of integration with subtractive methods as the layers are not particulate and remain resistant to etchings and drilling.

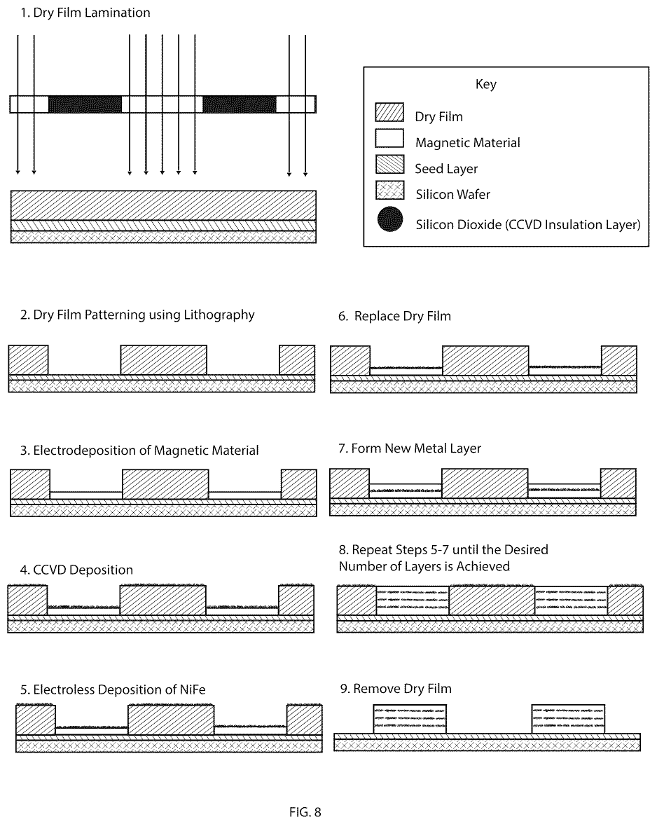

Electroless plating, therefore presents a simple method of creating a base for components to be formed out of by a subtractive method, usually involving but not limited to chemical etching, laser drilling or cutting, or mechanical drilling or cutting. However, a positive manufacturing process is more complicated as after each electroless plating step, the dry film would have to be removed. An exemplary embodiment of this process is shown in FIG. 8.

Step 1 of FIG. 8 involves the preparation of a dry film for patterning. In Step 2 the dry film is patterned. In Step 3, the initial magnetic layer is deposed. In Step 4, a CCVD process is undergone, which creates an imperfect insulation layer. In Step 5 the electroless plating occurs. It will be appreciated that the electroless plating will produce a layer of metal over all of the particulates. Because the particulates from Step 4 have been deposited on the dry film and the edges of the dry film, it can be beneficial to replace the dry film before beginning electroplating.

If an electroplating step directly followed the electroless step, the electroless layer would serve as a seed layer, and the electroplated layer would grow horizontally and vertically, preventing a subsequent particulate layer from forming as an edge-to-edge layer of the component. Therefore, before electroplating the magnetic layer, the dry film is in many cases to be replaced, as shown in Step 6 of FIG. 8 and this adds a repetitive step. This also removes the hybrid materials distinguishing characteristic of smooth side walls as dry film patterns have to be replaced.

Therefore, it can be beneficial to create hybrid material with at least one traditional hybrid insulation layer and at least one electroless insulation layer. By arranging these two layers you can increase the vertical resistivity well over bulk material and even traditional hybrid material while minimizing edge misalignment. For example, you could do a hundred traditional hybrid insulation layers to one pinched hybrid insulation layer or any other combination of layers. However, it must be noted that requiring the new dry film steps does not imply that other surface preparation steps are needed to begin the next layer, and as such this process is still less step-intensive than traditional laminated material processes.

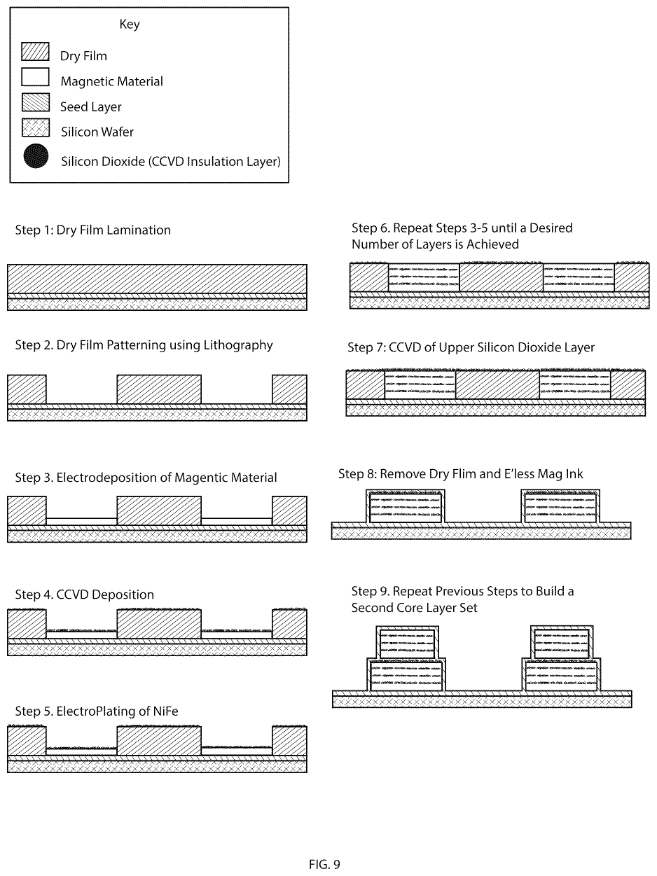

FIG. 9 shows an overview of an exemplary process being incorporated into a plating workflow where a NiFe component is being plated. The present invention may be applied to various metals and electrical components. NiFe, nickel, or other electroless plateable elements and alloys may be used to form apparatuses of this invention according to the various plating methods in which CCVD processes may be integrated.

Step 1 shows a dry film on an electroless seed layer, and step 2 shows the results of a dry film patterning. Steps 1 and 2 may be replaced with any process helpful in defining the component to be plated.

Step 3 shows the electrodeposition of a NiFe layer onto the seed layer to form an initial core layer for the component. After this layer is formed, as Step 4 shows, an imperfect SiO₂ layer is formed, and a CCVD process forms the SiO₂ layer. The formation of the imperfect SiO₂ layer is followed by Step 5. Step 5 is the electroplating plating of a NiFe layer. This creates an an-ungapped imperfect silicon dioxide layer. As noted by Step 6, steps 3 and 4 may be repeated until a desired number of layers is achieved. Typically, the desired number of layers will be determined by the skin depth as the eddy current generation increases as the core gets bigger.

Once Step 6 is complete, the entire apparatus receives a coating of silicon dioxide particulates, as shown in Step 7. The dry film is then stripped, and the layers undergo an electroless nickel-iron deposition, as shown in Step 8. This creates an extremely strong gapped silicon dioxide insulation layer 110. The gaps will contain some other material or element that is not the plated material but is related to the environment.

The second set of core layers may be built upon the first set of core layers according to the processes of Steps 1-6. This set of core layers will be thinner than the first set of core layers. This is due to dry film tolerances. By aiming to place the dry film onto the first core layers, the situation where there is space between the dry film and the first core layer set along the edge of the layer set is minimized. Thus, the chance of their being core material that has not received an insulation layer is minimized.

It will be appreciated that although the pinched insulation layer increases the vertical resistivity of the hybrid material it does not require a change in the materials used nor an increase in thickness of the insulation layer itself. This allows pinched hybrid materials to keep the same ease of implementation and use as traditional hybrid materials. Pinched hybrid materials also keep the small size of their traditional hybrid counterparts. In fact, the increase in resistivity can theoretically allow for pinched hybrid magnetic cores, for example, pinched hybrid nickel-iron cores to actually be smaller than the traditional hybrid cores for applications at the same frequency.

It would also make sense, if the resistivity is increased, that one could put less of the insulation layers into a hybrid material. However, as eddy currents at high frequencies are denser and require insulation layers to be closer together, regardless of thickness, this is not a likely outcome (although in some cases with lower frequencies, for example, fewer layers can be more cost-effective and are still practical). So, instead of fewer layers, a pinched hybrid core may be able to fit a greater number of thinner insulation layers into the core for even better performance at high frequency.

In all cases of pinched hybrid insulation layers and components, once the component or layer is built, it may be beneficial to shock it. In at least one exemplary embodiment, the resulting component is subject to a shocking process, which may be a thermal shock process.

The result of this electroless plating methodology includes better performing hybrid materials that may allow hybrid materials to handle greater frequencies, hold more layers, and even downsize—all while keeping the positive benefits of the hybrid materials like the ease of subtractive manufacturing while requiring additional materials to be utilized.

The drawings and figures show multiple embodiments and are intended to be descriptive of particular embodiments but not limited to the scope, number, or style of the embodiments of the invention. The invention may incorporate a myriad of styles and particular embodiments. All figures are prototypes and rough drawings: the final products may be more refined by one skill in the art. Nothing should be construed as critical or essential unless explicitly described as such. Also, the articles “a” and “an” may be understood as “one or more.” Where only one item is intended, the term “one” or other similar language is used. Also, the terms “has,” “have,” “having,” or the like are intended to be open-ended terms. The term “metal” is defined as a metal or an alloy thereof.

1. A method of producing a pinched gap hybrid material for magnetic components comprising;
preparing a layer of magnetic material;
forming an imperfect insulation layer onto the magnetic material layer; and
forming, by controlled autocatalytic deposition, a layer on a portion of the surface of the imperfect insulation layer until at least one pinched gap is created.

2. The method of claim 1, wherein the imperfect insulation layer is an imperfect particulate insulation layer.

3. The method of claim 1, wherein preparation of the layer of magnetic material occurs on a substrate core, a carrier, a wafer, or a film.

4. The method of claim 3 wherein the substrate cores are one or more of the following: an epoxy, a fiberglass, an Ajinomoto Build-Up film, a silicon, or a polymer substrate core.

5. The method of claim 1, further comprising forming an intermediary imperfect insulation layer on the surface of the metal layer, and at least once undertaking the following steps in sequence: forming an additional metal layer on the surface of the additional imperfect insulation layer and forming an additional insulation layer on a surface of the additional metal layer.

6. The method of claim 1, wherein the metal layer is nickel, iron, cobalt, or any alloy of any of these materials.

7. The method of claim 6, further comprising patterning pinched hybrid material into a magnetic core.

8. The method of claim 1, further comprising electroplating a metal layer onto a surface portion of the imperfect insulation layer, which was not subject to controlled autocatalytic deposition.

9. The method of claim 1 wherein the imperfect insulation layer has a coverage percentage between 90 and 99.99% and has a thickness of between 10 nm and 5 μm.

10. The method of claim 1, wherein the imperfect insulation layer is formed by an ink jet printing process.

11. A pinched gap hybrid material comprising;
A magnetic material layer; and
At least one pinched gap imperfect insulation layer with a set of voids embedded in the magnetic material so that some of the voids are pinched.

12. The apparatus of claim 11, further comprising a substrate operably connected to the lower surface of the magnetic layer.

13. The apparatus of claim 12, further comprising at least one metal layer with an additional pinched gap imperfect insulation layer embedded in the metal layer operably connected to a surface of the substrate opposite the pinched gap hybrid material.

14. The apparatus of claim 11, further comprising the pinched gap material integrated into a magnetic core.

15. The apparatus of claim 11, wherein the metal layer is a nickel, an iron, a cobalt, or an alloy of these materials.

16. The apparatus of claim 11, further comprising the pinched gap imperfect insulation layer with at least one gap filled with a metal.

17. The apparatus of claim 11, wherein the imperfect insulation layer is an imperfect particulate insulation layer.

18. The apparatus of claim 11, further comprising the hybrid material operably connected to a substrate, a core, a carrier, or a wafer.

19. The apparatus of claim 11, wherein the cores are one or more of the following: epoxy, fiberglass, Ajinomoto Build-Up film, silicon, polymers, various films or any core or core similar to what is in use in the printed circuit board, semiconductor packaging, semiconductor wafer, or lamination industry.

20. The apparatus of claim 11, wherein the magnetic material is a nickel-iron alloy.
